(19) United States
(12) Patent Application Publication
(10) Pub. No.: US 2005/0043555 A1
(43) Pub. Date: Feb. 24, 2005

(54) Production of high grade and high concentration of free fatty acids from residual residual oils, fats and greases

(76) Inventors: Juan Miguel Garro, Des Sables (CA); Louis Estaque, Beloeil (CA); Alain Lemieux, Thetford Mines (CA); Nicole Cadoret, Thetford Mines (CA); Paul Angers, Sainte Foy (CA); Paul Jollez, Sherbrooke (CA)

Correspondence Address: MCDERMOTT WILL & EMERY LLP, 600 13TH STREET, N.W., WASHINGTON, DC, 20005-3096, US

(21) Appl. No.: 10/275,077

(22) PCT Filed: May 2, 2001
(86) PCT No.: PCT/CA01/00616

(30) Foreign Application Priority Data
May 2, 2000 (CA) 2,307,450
Jun. 8, 2000 (CA) 2,310,992

(51) Int. Cl. C11C 3/00

(52) U.S. Cl. 554/126

(57) ABSTRACT

The present invention relates to a process for the production of unsaturated and saturated free fatty acids. The process comprises the steps of: (a) selecting a starting material from the group consisting of trap oils, trap greases, yellow greases and brown greases, (b) pre-treating the oils and/or greases selected in step (a) in order to separate the oils and/or greases, from residual solids and water and obtain a mixture consisting principally of saturated and unsaturated free fatty acids, (c) bleaching the mixture of free fatty acids obtained in step (b) in order to obtain a suitable coloration thereof, (d) fractionating the bleached free fatty acids obtained in step (c) in two fractions: saturated and unsaturated fatty acids, (e) purifying the unsaturated fatty acids obtained from step (d), and purifying the saturated fatty acids obtained from step (d).

### FIELD OF THE INVENTION

The present invention relates to the production of free fatty acids from residual oils, fats and greases. More precisely, the present invention relates to a process for the production of unsaturated and saturated free fatty acids from residual oils, fats and greases.

### BACKGROUND OF THE INVENTION

Most commercial unsaturated acids (i.e. oleic acid) are derived from animal tallow (by-product of the meat industry), tall oil (by-product of paper mills) or natural vegetable oils.

Fat splitting processes are well known in the art. The most common methods are:
1) Twichell process;
2) Batch autoclave process;
3) Continuous process; and
4) Enzymatic process.

In Twichell process, the fat is hydrolyzed at a temperature of 100° C. to 105° C. and at atmospheric pressure for 12 to 48 hours. Alkyl-aryl acid or cycloaliphatic sulfonic acid with sulfuric acid (0.75-1.25% w/w) are used as catalysts. Yields of 85%-95% are obtained. The main inconvenients of this process are the catalyst handling, long reaction time, tendency to form dark-colored acid and high labor cost.

In the batch autoclave operations, the fat is hydrolyzed in the presence or absence of a catalyst. Live steam is injected continuously at the bottom while venting a small amount to maintain the desired agitation and operating pressure. After settling and formation of an aqueous and a fatty acids phase, the fatty acids phase is treated with mineral acid to separate the soap formed. The fatty acids phase is further washed with water to remove traces of the mineral acid. Under catalytic conditions (i.e. zinc, calcium or magnesium oxides) the fatty acids phase is reacted for a period of 5 to 10 hours at 150° C. -175° C. A high yield of about 85%-95% is obtained. Without catalyst the fatty acids phase is reacted for a period of 2 to 4 hours at a high temperature (240° C.) to give similar yields. The principal inconvenient of this process is the catalyst handling, and high labor cost.

In continuous operations also known as the Colgate—Emery process, a single-stage countercurrent high pressure splitting is carried out for fat hydrolysis. The fat is introduced by means of a sparge ring from the bottom of the splitting tower while water is introduced by the top. The crude fat passes as a coherent phase from the bottom to the top, while heavier splitting water travels downward as a dispersed phase through the mixture of fat and fatty acids. The high temperatures involved (250° C. -260° C.) associated to high pressures (725 psi) assures degrees of splitting up to 98% in only 2 to 3 hours. The principal inconvenient of this process is the high cost associated with the equipment and the restriction to relative clean starting materials.

In enzymatic operations, the lipase from Candida rugosa, Aspergillus niger; and Rhizopus arrhizus had been studied at temperatures of 26° C. to 46° C. for periods of 48 to 72 hours. Even though 98% of splitting is claimed there is no commercial process available until now. The principal inconvenient of this process is that because enzymes work very well over a specific substrate under specific conditions, when the starting material is composed of more than one product, the reaction is less selective. Long reaction times and great volumes required to satisfy the optimal concentration are also current problems involved in this kind of procedure.

Fractionation of free fatty acids is commonly performed by distillation of tall oil. Tall oil is recovered in most paper mills by acidulation of the soap skimming from black liquor. Crude tall oil (CTO) consists of a mixture of fatty acids (40%-45%), resin acid (40%-45%) and various neutral components (i.e. hydrocarbons, wax alcohols, sterols, esters and residues). About 40% to 50% of the fatty acids contained in tall oil are oleic acid, while another 35% to 45% are linoleic acid. Higher quality of tall oil fatty acids, TOFA, (less than 2% of resins acid) can be obtained by distillation through two columns: a rosin column and a fatty acids column.

Oleic acid is probably the most important unsaturated fatty acids (UFA) because many applications have been developed for its use in different fields (i.e. cosmetics, chemicals, lubricants, textiles, etc.). Separation of oleic acid form tall oil distillates requires additional refining steps. Best known-process for fractionation of fatty acids by crystallization from solvent is the “Emersol” process, developed by Emery Industries Inc. in 1934. Different American patents used different solvents (methanol: U.S. Pat. No. 2,421,157; acetone: U.S. Pat. No. 2,450,235 and methyl formate: U.S. Pat. No. 3,755,389) to separate saturated fatty acids from unsaturated fatty acids. The process was optimized by addition of crystallizing promoters (neutral fats, tallow, and glycerol tri-stearate). One more refined promoter is described in Australian patent AU-28434/92. It is the reaction product of: 1) a polyhydric alcohol (i.e. glycerol, pentaerythritol, trimethylol pentane, etc.), 2) a dicarboxylic acid (i.e. adipic, oxalic, succinic, azelaic, glutaric and tartaric) and 3) a fatty acids.

All these process require explosion proof installations and low temperature refrigeration systems.

Other methods for producing oleic acid involve separation over molecular sieves (U.S. Pat. No. 4,529,551 and U.S. Pat. No. 4,529,551); lithium soap separation (U.S. Pat. No. 4,097,507), urea complexation (U.S. Pat. No. 2,838,480 and U.S. Pat. No. 4,601,856) and complexation with dienophiles (U.S. Pat. No. 5,194,640). All these process have the inconvenient of a high cost operation associated to the use of chemicals required.

Dry fractionation technology was originally developed for treatment of animal fat (i.e. beef tallow) in the 60's. Since this time, many improvements were performed in response to the ever-increasing demand of the industry for new products with very specific requirements. Two main sources are now the target of this technology: 1) vegetable oils such as palm oil, soybean oil, sunflower oil, rapeseed oil, groundnuts oil, cottonseed oil and palm kernel oil and 2) animal fats such as beef tallow, milk fat, lard and fish oil.

These fats and oils are mainly composed of triglycerides, diglycerides and monoglycerides (i.e. a broad range of melting points) constituting a large number of intersoluble glycerides that are very difficult to separate by dry fractionation (i.e. solvent free crystallization). The separation of a liquid fraction (i.e. olein, used in food oil) and a solid fraction (i.e. stearin, used in shortening and margarine) can be achieved through dry fractionation.

In the present invention, dry fractionation was used to separate purified free fatty acid obtained by splitting the residual oils and greases recuperated from industrial and commercial operations (i.e. trap greases, yellow greases and brown greases).

The free fatty acids obtained from these starting materials are mainly constituted by unsaturated fatty acids, such as mainly oleic acid, linoleic acid, linolenic acid and saturated fatty acids such as palmitic acid and stearic acid. The range of melting points for these limited number of products, in comparison with all the possible combinations presented by glycerides, was shown to be wide enough to perform a highly selective separation.

### SUMMARY OF THE INVENTION

An object of the present invention is to provide a process for the production of free fatty acids that uses residual oils, fats and greases as the starting material.

Another object of the present invention is to provide an inexpensive and simple way to produce high grade and high concentration of free fatty acids.

A further object of the invention is to overcome most of the drawbacks mentioned hereinabove.

More precisely, the objects of the present invention are provided by a process for producing unsaturated and saturated free fatty acids, the process comprising the steps of:
a) selecting a starting material from the group consisting of trap oils and greases, yellow greases and brown greases,
b) pre-treating the oils and/or greases selected in step a) in order to separate the oils and/or greases, from residual solids and water and obtain a mixture consisting principally of saturated and unsaturated free fatty acids,
c) bleaching the mixture of free fatty acids obtained in step b) in order to obtain a suitable coloration thereof,
d) fractionating the bleached mixture of free fatty acids obtained in step c) in two fractions: saturated and unsaturated fatty acids,
e) purifying the unsaturated fatty acids obtained from step d), and
f) purifying the saturated fatty acids obtained from step d).

The process of the present invention has the, advantage of using inexpensive starting material thereby reducing the cost all the while allowing the recycling of the starting material that is normally eliminated through costly treatments thereof.

The process of the present invention also has the advantage of giving the option of eliminating a hydrolysis step in the production of the free fatty acids, thereby simplifying the process for the production of fatty acids and reducing the production cost of same.

### BRIEF DESCRIPTION OF THE DRAWINGS

FIG. 1 is a graphical representation of the differential scanning calorimetry of free fatty acids of trap oils and greases used in the process of the present invention.

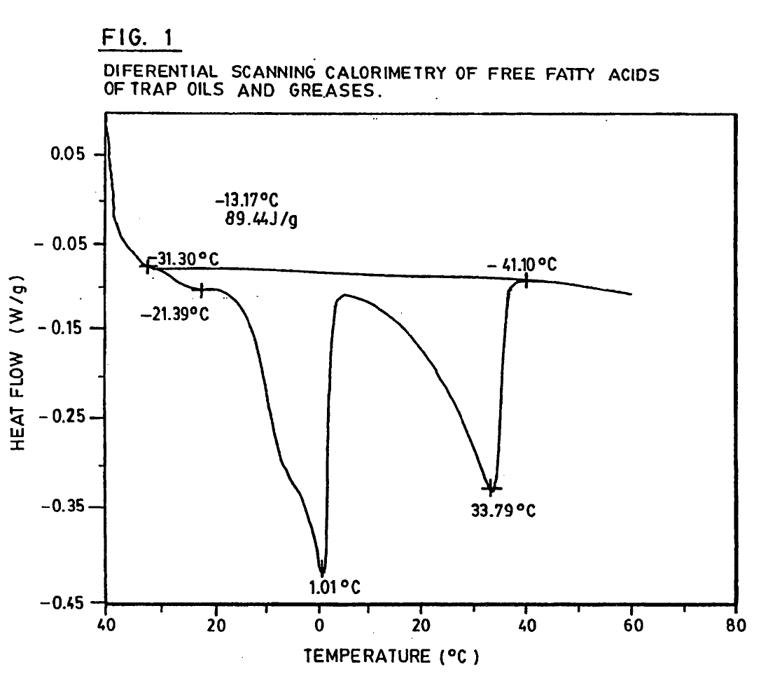

FIG. 2 is a graphical representation showing the cooling curve of the free fatty acids produced by the process of the present invention.

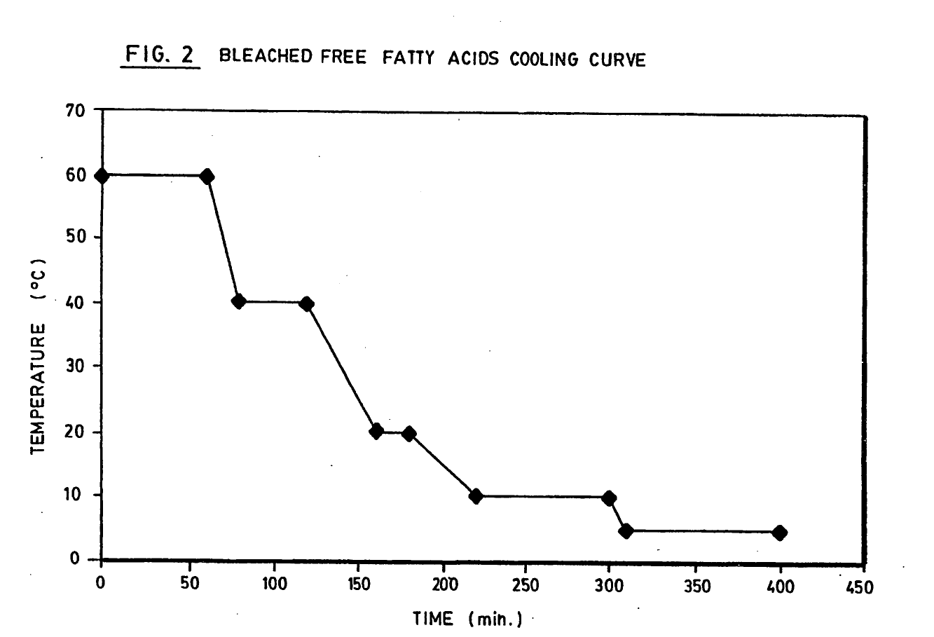

### DETAILED DESCRIPTION OF THE INVENTION

According to a preferred embodiment of the present invention, the process can be achieved in the following sequential step: 1) selecting a starting material from the group consisting of: trap oils, greases and fats; 2) pre-treating the selected oils, fats and greases in order to separate residual solids and water therefrom so to obtain a mixture consisting principally of saturated and unsaturated free fatty acids; 3) fat splitting of the pretreated mixture by hydrolysis or saponification 4) bleaching the hydrolysed or saponified free fatty acids; 5) fractionating the bleached free fatty acids so to obtain an unsaturated and a saturated fraction of fatty acids; 6) purifying the unsaturated fraction of fatty acids; and 7) purifying the saturated fraction of free fatty acids.

In step 1), the starting material is selected from the group consisting of: residual oils, fats and greases. This step is crucial and constitutes the gist of the present invention. The residual oils, fats and greases are post-consumers and/or by-products of industrial and commercial operations.

Three principal sources are trap oils and greases, yellow greases and brown greases.

Trap oils and greases are collected in the traps installed on the sewage water outlet of restaurants and food industries. These traps allow the collection of the oils and greases carried over with the wastewater of washing operations, before they reach the municipal sewage network. These greases are collected by dedicated trucks and sent to pre-treatment plants.

Yellow and brown greases are residual oils and greases from cooking operations. They are mainly collected in restaurants and food industries. Yellow greases have a low concentration of free fatty acids (acid value of about 5 to 15 mg KOH/g) as a result of its short and limited contact with water (i.e. moisture of food). As in the case of trap oils and greases used in frying process (i.e. high temperature in presence of air) principal alteration lead to oxidized monomers, dimers, oligomers, volatile compounds, cyclic monomers and non-polar compounds.

Trap oils and greases are mainly constituted of a mixture of oils and greases (3 to 10%), water (90 to 95%) and residual solids (1 to 5%). At room temperature, trap oils and greases form a non-homogeneous and unstable emulsion. They have a strong odor characteristic of acetic and/or butyric fermentation (i.e. fermentation of olives before oil extraction).

In step 2), once the starting material is selected, it undergoes a pre-treatment step for eliminating the water and residual solid present in the raw material. Different known methods may be used for eliminating water and residual solids. Such known methods may include hot filtration, in order to separate the suspended solids, and a hot decantation, in order to separate oils and greases from water. Decantation can be done in a batch mode in heated decanting tanks or in a continuous mode in a three phase dynamic separator where oils and greases are recovered in the upper phase (i.e. floating phase), the solids being decanted at the bottom of the separator and the water been extracted in the middle of the separator. Any temperature between 50° C. and 100° C. could be used for decanting, but preferably the temperature should range between 60° C. and 80° C.

The recovered oily phase is a mixture of free fatty acids, tri, di, and monoglycerides, trimers and dimer acids, oxidized monomers, unsaponifiables and other colored long chain oxidized products. A typical composition of pre-treated trap oil is: 98% oil, 2% residual solids and traces of water. The oil is mainly constituted by free fatty acids (acid value of about 130 to 160 mg KOH/g) coming from the natural enzymatic hydrolysis, which occurs during the lying time of the oils and greases in traps. A typical composition of pretreated trap oils and greases is presented in Table N^{o}1.

In step 3), the mixture principally comprising unsaturated and saturated free fatty acid obtained from the pre-treatment step may undergo fat splitting in order to complete the hydrolysis of the non-hydrolysed compounds (i.e. tri-, di- and monoglycerides). Fat splitting can be achieved by hydrolysis at high temperature and pressure. Typical temperature ranges from 150° C. to 260° C., and more preferably from 200° C. to 240° C. Typical pressure ranges from 75 psi to 500 psi and more preferably from 150 psi to 450 psi. The reaction time can vary between 1 to 6 hours and more preferably between 2 to 4 hours. Metal oxide catalysts, such as zinc, calcium, and magnesium could favor the reaction at a concentration by weight of 1% to 5% and more preferably 2% to 4%. A typical composition of free fatty acids (FFA) obtained by hydrolysis is presented in Table N^{o}1. Typical color values are shown in Table N^{o}2.

Fat splitting could also be achieved by saponification under controlled temperature and pressure conditions. Suitable temperature or pressure conditions for saponification are about 100° C. to 150° C. and about 20 to 50 psi respectively. After saponification, the mixture is cooled to about 85° C. to 95° C. Neutralization is carried out with a mineral acid selected from the group consisting of H₂SO₄, H₃PO₄, HCl and the like, at a pH of about 5 to 7. Separation of the aqueous phase leads to the oily phase containing free fatty acids (FFA).

In step 4), the so-obtained mixture of unsaturated and saturated free fatty acids is bleached in order to give a suitable coloration thereof. Various known bleaching procedures namely adsorption, treatment with hydrogen peroxide (H₂O₂) or various distillation techniques may be used.

Bleaching by adsorption is carried out with one adsorbent or a combination of adsorbents of the group consisting of: silica gel, crystalline silica, bentonite, Fuller's earth, diatomaceous earth and activated carbon. Bleaching could be performed in a batch or continuous mode by percolation in different columns. This step may further be carried out at a temperature varying from 100° C. to 150° C. and more preferably from 115° C. to 130° C. The time reaction may vary from 15 minutes to 1 hour and more preferably from 30 minutes to 45 minutes.

When the bleaching step is carried out by adsorption, inert atmosphere is strongly recommended. Under batch mode it could be successfully achieved under vacuum and in continuous mode it can be achieved under nitrogen atmosphere. A typical composition for bleached free fatty acids (FFA) obtained under batch conditions is presented in Table N^{o}1. Typical color values are shown in Table N^{o}2.

Bleaching by treatment with a hydrogen peroxide solution (H₂O₂ at 35% w/w) may be achieved at a temperature of 80° C. for one hour. Concentration by weight of the peroxide solution could be at 1%, 10% or 30% but more preferably at 10%.

Bleaching by distillation techniques such as the ones selected from the group consisting of falling film evaporation, wiped film evaporation, fractional distillation and molecular distillation may also be carried out.

One particular method for bleaching (known as “short path”) is based in the separation of the colorful products by molecular distillation. Industrially this application could be done by a vacuum thin-film distillation process, which permits distillation at very reduced pressure (i.e. between 0.1 mm Hg −5 mm Hg) and at a temperature ranging between 150°-200° C.

The equipment used for the molecular distillation comprises essentially a vertical which one double jacketed cylinder with an internal condenser and a rotating roller wiper system. Free fatty acids (FFA) are heated until complete homogenization. They are then continuously fed onto the rotating distributor and thrown by centrifugal force on a heated wall. They are further uniformly distributed by wiping elements while flowing downwards.

The internal condenser and film of the product to be evaporated (i.e. 1 mm thick) are so close that condensation is almost instantaneous. The very short residence time (i.e. about 1 minute) avoid degradation reactions and limit the risk of fouling in the internal wall of the cylinder. The absence of oxygen (i.e. high vacuum) also contributes to prevent most common degradations associated to air oxidation.

In another preferred embodiment, the bleaching of the free fatty acids is carried out by molecular distillation. The main interest of this bleaching technique is to furnish a high quality material that could be directly fractionated without the fat splitting operation. Table N^{o}1 shows the composition of trap oils and greases pretreated and distilled by molecular distillation. It is evident that the quality is as good as, if not better, than those bleached free fatty acids (FFA) obtained by other techniques such as clay and hydrogen peroxide.

Thus the fat splitting step 3) is eliminated when the mixture are bleached by molecular distillation.

In this case the process is reduced to the following steps:
a) Pre-treatment of the trap oil and greases.
b) Molecular distillation of the pretreated trap oils and greases.
c) Fractionation of the resulting distillate in two fractions: saturated and unsaturated.
d) Purification of unsaturated fatty acids (UFA).

e) Purification of saturated fatty acids (SFA).

TABLE N1
Typical properties and compositions for different products
obtained at different stages of the process

| | | Properties | | | | | | | |
|---|---|---|---|---|---|---|---|---|---|
| | | Trap Oil & Greases | | | | | | | |
| | | | Pretreated* & | Free Fatty | Bleached | | | Free Fatty Acids | |
| | | | Molecular | Acids | Free Fatty Acids | | | Unsaturated | Saturated |
| | | Pretreated* | Distilled | (FFA) | Clay | H₂O₂ | Mol. Dist. | (UFA)** | (SFA)** |
| Acid Value (mg KOH/g) | | 157 | 189 | 183 | 183 | 180 | 186 | 169 | 188 |
| Volatile (%) | | | | 1.8 | 1.2 | 2.1 | | 0.9 | 0.1 |
| Composition | | | | | | | | | |
| Capric Acid (%) | 10:00 | 0.2 | 0.2 | 0.15 | 0.15 | | | 0.19 | |
| Lauric Acid (%) | 12:00 | 0.2 | 0.4 | 0.33 | 0.33 | 0.2 | 0.2 | 0.41 | 0.2 |
| Myristic Acid (%) | 14:00 | 1.1 | 1.4 | 1.28 | 1.38 | 1.1 | 1.2 | 1.24 | 1.68 |
| Palmitic Acid (%) | 16:00 | 15.7 | 19.4 | 17.85 | 17.77 | 15.8 | 19.0 | 5.44 | 42.78 |
| Margaric Acid (%) | 17:00 | 0.1 | 0.2 | 0.26 | 0.26 | | 0.3 | — | 0.75 |
| Stearic Acid (%) | 18:00 | 7.8 | 8.8 | 9.2 | 7.81 | 7.8 | 7.8 | 1.44 | 21.02 |
| Arachldic Acid (%) | 20:00 | | | 0.86 | 0.76 | | | — | — |
| Myristoleic Acid (%) | 14:01 | | 0.2 | — | — | | 0.1 | | |
| Palmltoleic Acid (%) | 16:01 | 2.4 | 3.0 | 2.42 | 2.52 | 2.0 | 2.5 | 3.27 | 0.95 |
| Heptadecenoic Acid (%) | 17:01 | | | 0.20 | 0.19 | | | 0.25 | — |
| Oleic Acid (%) | 18:1c | 45.4 | 44.2 | 43.3 | 44.97 | 40.6 | 45.5 | 57.78 | 20.60 |
| Elaldic Acid (%) | 18:1t | | | 5.29 | 5.31 | | | 5.47 | 4.89 |
| Linoleic Acid (%) | 18:2c | 13.2 | 14.2 | 14.17 | 13.17 | 10.3 | 12.3 | 17.40 | — |
| Linolelaidic Acid (%) | 18:2t | | | 1.67 | 1.87 | | | 2.11 | 5.18 |
| Linolenic Acid (%) | 18:03 | 1.8 | 1.8 | 1.82 | 1.62 | 0.9 | 1.3 | 0.96 | 0.59 |
| Others (%) | | 0.8 | 0.7 | | | 0.8 | 1.3 | | |
| Total FAA (%) | | 88.7 | 94.5 | 98.8 | 98.11 | 79.5 | 91.5 | 95.96 | 98.64 |
| Total Unsaturated (UFA) (%) | | 62.8 | 63.4 | 68.87 | 69.65 | 53.8 | 61.7 | 87.24 | 32.2 |
| Total Saturated (SFA) (%) | | 25.1 | 30.4 | 29.93 | 28.46 | 24.9 | 28.5 | 8.72 | 66.43 |

*Hot decanted and filtered
**Fractionated after clay bleaching

TABLE NO 2
Typical color for different products obtained at different stages of
the process.

| | Pretreated Fat | Free Fatty | Bleached Free | | Free Fatty Acids | |
|---|---|---|---|---|---|---|
| | Oils & Greases | Acids | Fatty Acids | | Unsaturated | Saturated |
| | Molecular Dist.** | (FFA) | Clay | H₂O₂ | (UFA)* | (SFA)* |
| Color FAC | | >45 | <7 | <11 B | <11 | <1 |
| (AOCS CC 13a-43) | | | | | | |
| Yellow 1″ Lovibond | 25 | Out of range | 10 | 50 | 21 | 3 |
| (AOCS CC 13b-45) | | | | | | |
| Red 1″ Lovibond | 3 | Out of range | 3.2 | 6 | 4.8 | 1 |
| (AOCS CC 13b-45) | | | | | | |

*Fractionated after clay bleaching.
**Measured in the 5¼″ Lovibond's scale.
***After hydrolysis (without any molecular distillation treatment).

In step 5), fractionation of bleached free fatty acids or pretreated and molecular distilled trap oils and greases could be achieved by different methods:
a) By quenching the bleached free fatty acids oils in a solvent at low temperatures. Solvent could be one selected from the group consisting of hexane, acetone, isopropyl alcohol and ethanol. The reaction temperature may range from −5° C. to −20° C. Unsaturated fatty acids (UFA) are dissolved in the solvent while saturated fatty acids (SFA) precipitates under these conditions. Filtration could be easily achieved by a filter press, a Sparkler filter, a centrifuge or similar equipment.
b) By crystallization of saturated fatty acids (SFA) using a detergent that coats the crystals, then increasing their specific weight. Filtration could be achieved by previously described equipment.
c) By dry fractionation, based on differences between melting points of saturated (SFA) and unsaturated (UFA) free fatty acids. The principal advantages of this technology are that there is no solvent required and the temperature range is warmer than previous cases (i.e. over zero degrees). Differential Scanning Calorimetry (DSC) was used in order to determine the best cooling profile. FIG. N^{o}1 shows the spectra for free fatty acids obtained after splitting of trap oils and greases.

Crystallization is carried out by a detailed program of cooling (i.e. precision of 0.1° C.). Details of this program are shown in FIG. N^{o}2: Bleached Free Fatty Acids cooling curve.

It is important to note that unsaturated fatty acids (UFA) and saturated fatty acids (SFA) are mutual contaminants. Poor filtration lets important quantities of UFA in SFA reducing the yield of UFA and decreasing the purity of SFA. This problem could be successfully overcome by using a filter press under pressure. Pressure is generated by squeezing the membrane, which Wraps the filter cloth. A refrigerated liquid or gas could generate the pressure in order to keep the right temperature of crystallization. Pressures could vary from 10 bars to 30 bars.

In step 6), unsaturated free fatty acids (UFA) are finally purified by another treatment of bleaching in similar conditions then that of free fatty acids (FFA).

In step 7), saturated free fatty acids (SFA) cake's is melted and send to be distillated. Any distillation procedure (i.e. falling film evaporation, wiped film evaporation, fractional distillation and molecular distillation) could be successfully achieved to separate stearic acid from palmitic acid due to the difference in their vapor pressures at high temperature (Table N^{o}4 and Table N^{o}5).

TABLE NO 4
Vapor Pressures of Palmitic and Stearic Acids.

Vapor Pressure (mm Hg)

| Temperature (° C.) | Palmitic | Stearic |
|---|---|---|
| 200 | 6.15 | 2.60 |
| 230 | 22.53 | 10.56 |
| 260 | 67.01 | 41.15 |

TABLE NO 5
Boiling Points of Palmitic and Stearic Acids.

| Vapor Pressure | Boiling Point (C.) | | | | | | |
|---|---|---|---|---|---|---|---|
| (mm Hg) | 1 | 2 | 4 | 8 | 16 | 32 | 64 |
| Palmitic Acid | 165.9 | 178.0 | 191.2 | 205.7 | 221.5 | 239.1 | 258.6 |
| Stearic Acid | 182.5 | 195.0 | 208.6 | 223.6 | 240.0 | 285.3 | 278.6 |

Although the present invention has been explained hereinabove by way of a preferred embodiment thereof, it should be pointed out that any modifications to this preferred embodiment within the scope of the present invention is not deemed to alter or change the nature and scope of the present invention.

1. A process for producing unsaturated and saturated free fatty acids, the process being characterized in that it comprises the steps of:
a) selecting a starting material from the group consisting of trap oils, trap greases, yellow greases and brown greases,
b) pre-treating the oils and/or greases selected in step a) in order to separate the oils and/or greases from water and obtain a mixture consisting principally of saturated and unsaturated free fatty acids,
c) bleaching the mixture of free fatty acids obtained in step b) in order to obtain a suitable coloration thereof,
d) fractionating the bleached free fatty acids obtained in step c) in two fractions: saturated and unsaturated,
e) purifying the unsaturated fatty acids obtained from step d), and
f) purifying the saturated fatty acids obtained from step d).

2. A process according to claim 1, characterized in that it further comprises a fat splitting step of the mixture of saturated and unsaturated free fatty acids obtained in step b), prior to the bleaching step c).

3. A process according to claim 2, characterized in that the fat splitting step is carried out by hydrolysis or saponification of the oil and/or greases obtained in step b),

4. A process according to claim 3, characterized in that the fat splitting is carried out by hydrolysis at a temperature varying between 150° C. to 260° C. and at a pressure varying between 76 psi and 500 psi.

5. A process according to claim 3, characterized in that the fat splitting is carried out by saponification at a temperature varying between 100° C. and 150° C. and at a pressure varying between 20 psi and 50 psi.

6. A process according to any one of claims 1 to 5, characterized in that in step b), the pretreatment comprises hot filtration and decantation of oils or/and greases selected in step a).

7. A process according to any one of claims 2 to 6, characterized in that in step c), the bleaching is carried out by adsorption with an adsorbent selected from the group consisting of silica gel, crystalline silica, bentonite, Fuller's earth and a mixture thereof.

8. A process according to claim 7, characterized in that the bleaching of the free fatty acids is carried out in a batch or continuous mode by percolation in different columns.

9. A process according to claim 8, characterized in that the bleaching is carried out at a temperature ranging from 100° C. to 150° C. for a period ranging from 15 minutes to 1 hour.

10. A process according to claim 8 or 9, characterized in that the bleaching is carried in a batch mode under vacuum.

11. A process according to claim 8 or 9, characterized in that the bleaching is carried out in continuous mode under nitrogen atmosphere.

12. A process according to any one of claims 2 to 6, characterized in that the bleaching step c) is carried by a treatment with a sufficient amount of hydrogen peroxide at a temperature varying from 60° C. to 90° C. for a period varying from 20 minutes to 3 hours.

13. A process according to claim 12, characterized in that the concentration of the hydrogen peroxide ranges from 10 to 30% by weight

14. A process according to claim 12 or 13, characterized in that the bleaching step is carried out at a temperature of 80° C. for a period of 1 hour.

15. A process according to any one of claims 2 to 6, characterized in that the bleaching step c) is carried out by molecular distillation by a vacuum thin-film distillation step at a temperature varying from 150° C. to 200° C. and at a pressure varying from 0.1 to 5 mm Hg.

16. A process according to claim 15, characterized in that the bleaching step is carried out at a temperature varying from 165° C. to 185° C. and at a pressure varying from 0.2 to 0.5 mm Hg.

17. A process according to claim 1, characterized in that the bleaching step is carried out by molecular distillation by a vacuum thin-film distillation step.
